(19) United States
(12) Patent Application Publication
(10) Pub. No.: US 2005/0266316 A1
(43) Pub. Date: Dec. 1, 2005

(54) Non-aqueous electrolyte secondary battery

(76) Inventors: Hideki Kitao, Kobe-city (JP); Toyoki Fujihara, Tokushima (JP); Kazuhisa Takeda, Itano-gun (JP); Takaaki Ikemachi, Kobe-city (JP); Toshiyuki Nohma, Kobe-city (JP)

Correspondence Address: KUBOVCIK & KUBOVCIK, SUITE 710, 900 17TH STREET NW, WASHINGTON, DC, 20006, US

(21) Appl. No.: 11/138,272

(22) Filed: May 27, 2005

(30) Foreign Application Priority Data
May 28, 2004 (JP) 2004-158781

(51) Int. Cl. H01M 2/16; H01M 4/52; H01M 4/50; H01M 4/48

(52) U.S. Cl. 429/246; 429/231.1; 429/223; 429/224

(57) ABSTRACT

A non-aqueous electrolyte secondary battery that uses a layered lithium-transition metal composite oxide as a positive electrode active material can alleviate reduction in battery capacity associated with charge-discharge cycling at high temperatures and can enhance elevated-temperature durability, that is, high-temperature cycle performance. A non-aqueous electrolyte secondary battery includes a positive electrode containing a positive electrode active material capable of intercalating and deintercalating lithium, a negative electrode containing a negative electrode active material capable of intercalating and deintercalating lithium, and a non-aqueous electrolyte having lithium ion conductivity. The non-aqueous electrolyte secondary battery uses a layered lithium-transition metal composite oxide superficially coated with microparticles of Al₂O₃ as the positive electrode active material.

### BACKGROUND OF THE INVENTION

1. Field of the Invention

The present invention relates to non-aqueous electrolyte secondary batteries such as lithium secondary batteries.

2. Description of Related Art

A high energy density battery can be built with a non-aqueous electrolyte secondary battery that uses as a positive electrode active material a layered lithium-transition metal composite oxide, such as a lithium cobalt oxide and a lithium nickel oxide, because such a battery attains a large capacity and a high voltage, i.e., about 4 V. A problem, however, with using such positive electrode active materials is, however, that battery capacity degrades when the battery is charged and discharged repeatedly under a high temperature environment.

To solve this problem, such a technique has been proposed that the transition metal site in the lithium-transition metal composite oxide is substituted by a different kind of element or that the oxygen site is substituted by fluorine. For example, Japanese Published Unexamined Patent Application No. 8-213015 proposes a technique for suppressing oxidation decomposition of the electrolyte solution on the surface of a lithium-transition metal composite oxide and stabilizing the crystal structure by adding a different kind of element such as Al to the lithium-transition metal composite oxide.

However, when the transition metal site is substituted by adding a different kind of element such as Al to the positive electrode active material as in the foregoing, a problem arises that battery capacity reduction occurs.

### BRIEF SUMMARY OF THE INVENTION

Accordingly, it is an object of the present invention to provide a non-aqueous electrolyte secondary battery, using a layered lithium-transition metal composite oxide as the positive electrode active material, that can alleviate the reduction in battery capacity associated with charge-discharge cycling at high temperatures and enhance elevated-temperature durability, that is, high-temperature cycle performance.

In order to accomplish the foregoing and other objects, the present invention provides a non-aqueous electrolyte secondary battery, comprising a positive electrode containing a positive electrode active material capable of intercalating and deintercalating lithium, a negative electrode containing a negative electrode active material capable of intercalating and deintercalating lithium, and a non-aqueous electrolyte having lithium ion conductivity, wherein the positive electrode active material is a layered lithium-transition metal composite oxide superficially coated with microparticles of Al₂O₃.

### BRIEF DESCRIPTION OF THE DRAWING

FIG. 1 is a schematic view illustrating a three-electrode beaker cell produced in one example of the present invention.

### DETAILED DESCRIPTION OF THE INVENTION

The positive electrode active material used in the present invention is a layered lithium-transition metal composite oxide superficially coated with microparticles of Al₂O₃. In the present invention, the term “superficially coated” is intended to describe a state in which microparticles of Al₂O₃ adhere onto the surface of the layered lithium-transition metal composite oxide. Accordingly, microparticles of Al₂O₃ need not cover the surface of the lithium-transition metal composite oxide entirely, but rather, it is sufficient that the microparticles cover at least part of the surface thereof.

Using, according to the present invention, a layered lithium-transition metal composite oxide superficially coated with microparticles of Al₂O₃ makes it possible to alleviate the reduction in battery capacity resulting from repeated charging and discharging at high temperatures. Thus, elevated-temperature durability, that is, high-temperature cycle performance can be enhanced. The details of the reason why high-temperature cycle performance can be enhanced are not clear, but it is believed that coating the positive electrode active material with microparticles of Al₂O₃ serves to suppress deterioration of the active material surface that is caused by direct contact between the positive electrode active material and the non-aqueous electrolyte. Moreover, it is believed that because coating the surface of the lithium-transition metal composite oxide with microparticles of Al₂O₃ serves to reduce the amount of remaining alkali in the lithium-transition metal composite oxide, side reactions between the electrolyte solution and the remaining alkali may be thereby suppressed; thus, high-temperature cycle performance can be enhanced.

In the present invention, an example of the method of coating the surface of lithium-transition metal composite oxide with microparticles of Al₂O₃ includes mixing the lithium-transition metal composite oxide and microparticles of Al₂O₃ using a mixer that can apply a large shearing stress thereto so as to cause the microparticles of Al₂O₃ to physically adhere onto the surface of the lithium-transition metal composite oxide.

In the present invention, the coating amount of the microparticles of Al₂O₃ with respect to the layered lithium-transition metal composite oxide is preferably within the range of from 0.1 to 3.0 mole %, and more preferably within the range of from 0.3 to 1.0 mole % with respect to the composite oxide. If the coating amount of the microparticles of Al₂O₃ is less than 0.1 mole %, sufficient elevated-temperature durability (i.e., high-temperature cycle performance) may not be attained. On the other hand, if the coating amount exceeds 3.0 mole %, rate characteristics or the like may degrade although elevated-temperature durability (high-temperature cycle performance) improves.

It is preferable that the average particle diameter of the coating Al₂O₃ particles be 0.3 μm or less, and more preferably 0.2 μm or less. By restricting the average particle diameter of the Al₂O₃ particles to be 0.3 μm or less, the surface of the lithium-transition metal composite oxide can be coated more uniformly. The average primary particle diameter of the lithium-transition metal composite oxide is generally about 1 μm to 3 μm.

It is preferable that the layered lithium-transition metal composite oxide used in the present invention contain Ni, for the purpose of increasing battery capacity. For the purpose of enhancing structural stability, it is more preferable that the layered lithium-transition metal composite oxide further contain Mn, and still more preferable that the layered lithium-transition metal composite oxide further contain Co.

The layered lithium-transition metal composite oxide used in the present invention is preferably represented by the general formula Li[LiₐMnₓNi_{y}Co_{z}M_{b}]O₂, where M is at least one element selected from the group consisting of B, F, Mg, Al, Ti, Cr, V, Fe, Cu, Zn, Nb, Zr, and Sn; and a, b, x, y, and z satisfy the equations 1.02≦(1.0+a)/(b+x+y+z)≦1.30, a+b+x+y+z=1, 0≦b≦0.1, 0.01≦x≦0.5, 0.01≦y≦0.5, and z≧0.

Additionally, in the present invention, the layered lithium-transition metal composite oxide superficially coated with microparticles of Al₂O₃ may be mixed with a lithium-manganese composite oxide having a spinel structure, to be used a positive electrode active material. The lithium-manganese composite oxide having a spinel structure may further contain at least one element selected from the group consisting of B, F, Mg, Al, Ti, Cr, V, Fe, Co, Ni, Cu, Zn, Nb, and Zr.

When the layered lithium-transition metal composite oxide coated with microparticles of Al₂O₃ and a lithium-manganese composite oxide having a spinel structure are mixed for use as a positive electrode active material, it is preferable that the weight ratio of the mixture (lithium-transition metal composite oxide:lithium-manganese composite oxide) be within the range of 1:9 to 9:1, and more preferably within the range of 6:4 to 9:1. By mixing the lithium-manganese composite oxide with the lithium-transition metal composite oxide within these ranges, elevated-temperature durability can be improved further.

In the present invention, although the negative electrode active material used for the negative electrode is not particularly limited as long as it is usable for non-aqueous electrolyte secondary batteries, carbon materials are preferably used. Among the carbon materials, graphite materials are particularly preferable.

For the non-aqueous electrolyte, any electrolyte that is used for non-aqueous electrolyte secondary batteries may be used without limitation. The solvent of the electrolyte is not particularly limited, and usable examples include: cyclic carbonates, such as ethylene carbonate, propylene carbonate, butylene carbonate, and vinylene carbonate; and chain carbonates, such as dimethyl carbonate, methyl ethyl carbonate, and diethyl carbonate. Particularly preferable is a mixed solvent of a cyclic carbonate and a chain carbonate. An additional example is a mixed solvent of one of the above-described cyclic carbonates and an ether-based solvent such as 1,2-dimethoxyethane or 1,2-diethoxyethane.

The solute of the electrolyte is not particularly limited; examples thereof include LiPF₆, LiBF₄, LiCF₃SO₃, LiN(CF₃SO₂)₂, LiN(C₂F₅SO₂)₂, LiN(CF₃SO₂)(C₄F₉SO₂), LiC(CF₃SO₂)₃, LiC(C₂F₅SO₂)₃, LiAsF₆, LiClO₄, Li₂B₁₀Cl₁₀, Li₂B₁₂Cl₁₂, LiB(C₂O₄)2, LiB(C₂O₄)F₂, LiP(C₂O₄)₃, LiP(C₂O₄)₂F₂, and mixtures thereof.

Using, according to the present invention, a layered lithium-transition metal composite oxide superficially coated with microparticles of Al₂O₃ as a positive electrode active material makes it possible to alleviate the battery capacity reduction associated with charge-discharge cycling at high temperatures and enhance elevated-temperature durability (high-temperature cycle performance).

### DESCRIPTION OF THE PREFERRED EMBODIMENTS

Hereinbelow, the present invention is described in further detail. It should be construed, however, that the present invention is not limited to the following preferred embodiments but various changes and modifications are possible without departing from the scope of the invention as defined in the appended claims.

### EXAMPLE 1

Preparation of Lithium-Transition Metal Composite Oxide Coated with Al₂O₃ Microparticles

150 g of LiNi_{0.4}Co_{0.3}Mn_{0.3}O₂ having an average secondary particle diameter of 10 μm and 0.80 g of Al₂O₃ having an average particle diameter of 0.1 μm (0.5 mole % with respect to the transition metal Ni_{0.4}Co_{0.3}Mn_{0.3}) were charged into a mechanofusion system AM-20FS made by Hosokawa Micron Corp. and mixed for 5 minutes at 1500 rpm. The state of the mixed powder was observed with a scanning electron microscope (SEM), and as a result it was confirmed that microparticles of Al₂O₃ adhered uniformly onto the surface of the lithium-transition metal composite oxide having a primary particle diameter of about 1 μm.

Preparation of Positive Electrode The lithium-transition metal composite oxide superficially coated with microparticles of Al₂O₃, which was prepared in the above-described manner, and a lithium-manganese composite oxide (Li_{1.1}Al_{0.1}Mn_{1.8}O₄) having a spinel structure were mixed at a weight ratio (lithium-transition metal composite oxide:lithium-manganese composite oxide) of 7:3, and the resultant mixture was used as a positive electrode active material. This mixture (positive electrode active material), a carbon material as a conductive agent, and an N-methyl-2-pyrrolidone solution in which polyvinylidene fluoride was dissolved, as a binder agent, were mixed so that the weight ratio of the active material, the conductive agent, and the binder agent resulted in 90:5:5, to prepare a positive electrode slurry. The prepared slurry was applied onto an aluminum foil as a current collector, and then dried. Thereafter, the resultant current collector was pressure-rolled using pressure rollers, and a current collector tab was attached thereto. A positive electrode was thus prepared.

Preparation of Negative Electrode Graphite as a negative electrode active material, SBR as a binder agent, and an aqueous solution in which carboxymethylcellulose was dissolved as a thickening agent were kneaded so that the weight ratio of the active material, the binder agent, and the thickening agent became 98:1:1, and thus, a negative electrode slurry was prepared. The prepared slurry was applied onto a copper foil as a current collector, and then dried. Thereafter, the resultant current collector was pressure-rolled using pressure rollers, and a current collector tab was attached thereto. A negative electrode was thus prepared.

Preparation of Electrolyte Solution

LiPF₆ as a solute was dissolved at 1 mole/liter in a solvent in which ethylene carbonate (EC) and diethyl carbonate (DEC) were mixed at a volume ratio of 3:7. An electrolyte solution was thus prepared.

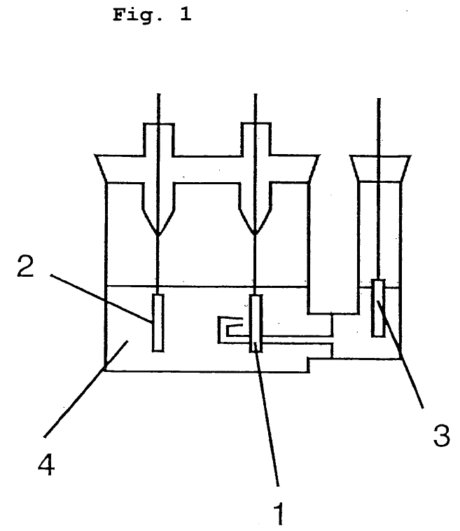

Preparation of Three-Electrode Beaker Cell A three-electrode beaker cell A1as illustrated in FIG. 1 was fabricated using the positive electrode prepared in the above-described manner for a working electrode, and metallic lithium for a counter electrode and a reference electrode. As illustrated in FIG. 1, an electrolyte solution 4 was filled in a container of the beaker cell, and the working electrode 1, the counter electrode 2, and the reference electrode 3 were immersed in the electrolyte solution 4. The electrolyte solution prepared in the above-described manner was used as the electrolyte solution 4.

Assembling of Non-Aqueous Electrolyte Secondary Battery

The positive electrode and the negative electrode prepared in the above-described manner were coiled around with a polyethylene separator interposed therebetween to prepare a wound assembly. In a glove box under an argon atmosphere, the resultant wound assembly was enclosed into a battery can together with the electrolyte solution. Thus, a cylindrical 18650 size (with 18 mm diameter and 65 mm height) non-aqueous electrolyte secondary battery A2 having a rated capacity of 1.4 Ah was fabricated.

COMPARATIVE EXAMPLE 1

A three-electrode beaker cell B1 and a cylindrical 18650 size non-aqueous electrolyte secondary battery B2 having a rated capacity of 1.4 Ah were prepared in the same manner as in Example 1, except that a lithium-transition metal composite oxide (LiNi_{0.4}Co ₃Mn_{0.3}O₂) that was not superficially coated with microparticles of Al₂O₃, that is, a lithium-transition metal composite oxide that was not mixed with microparticles of Al₂O₃, was used in place of the lithium-transition metal composite oxide superficially coated with microparticles of Al₂O₃ in Example 1.

COMPARATIVE EXAMPLE 2

Source materials of lithium-transition metal composite oxide and microparticles of AL₂O₃ were mixed together in place of carrying out the mixing process of the lithium-transition metal composite oxide with microparticles of Al₂O₃ as in Example 1, and the resultant mixture was baked to prepare a lithium-transition metal composite oxide. Specifically, Li₂CO₃, (Ni_{0.4}Co_{0.3}Mn_{0.3})₃O₄, and Al₂O₃ were mixed together, and the resultant mixture was baked at 900° C. for 20 hours in an air atmosphere, whereby a lithium-transition metal composite oxide was prepared. The content of Al₂O₃ was 0.5 mole % with respect to the transition metal Ni_{0.4}Co_{0.3}Mn_{0.3}. A positive electrode was prepared in the same manner as in Example 1 except that the lithium-transition metal composite oxide thus prepared was used, and then, a three-electrode beaker cell C1 was fabricated except that the positive electrode thus prepared was used as the working electrode.

Measurement of Discharge Capacity of Three-Electrode Beaker Cell

Discharge capacities of the three-electrode beaker cells A1, B1, and C1 were measured. The measurement of discharge capacity was conducted as follows. Each battery was charged to 4.3 V using a two-step charging, with 9.3 mA and 3.1 mA, and thereafter, with setting the end-of-discharge voltage at 3.1 V, the battery was discharged with 9.3 mA to 3.1 V, wherein the capacity of the battery was measured. The obtained capacity at that time was taken as the discharge capacity. The results of the measurement are shown in Table 1.

TABLE 1

| | | Discharge Capacity |
|---|---|---|
| | Battery | (mAh/g) |
| Ex. 1 | A1 | 156 |
| Comp. Ex. 1 | B1 | 157 |
| Comp. Ex. 2 | C1 | 141 |

Measurement of Battery's Rated Capacity

Rated capacities of the batteries A2 and B2 were measured. To obtain the rated capacity of the battery, the battery was charged with a 1400 mA constant current-constant voltage (cut-off at 70 mA) to 4.2 V, and then, with setting the end-of-discharge voltage at 3.0 V, discharged at 470 mA to 3.0 V, wherein the battery capacity was obtained and taken as the rated capacity.

Cycle Performance Test

Cycle performance test was carried out for the batteries A2 and B2. The cycle performance test was conducted by subjecting the batteries to 100 cycles of charge and discharge with a constant power of 10 W, an end-of-charge voltage of 4.2 V, and an end-of-discharge voltage of 2.4 V. The atmosphere temperature was set at 45° C., and the rated capacity after 100 cycles was measured to calculate the percentages of capacity degradation. The percentages of capacity degradation of the batteries are shown in Table 2.

Table 2 also shows the amounts of remaining alkali in the lithium-transition metal composite oxides used in Example 1 and Comparative Example 1. To obtain the amounts of the remaining alkali, 5 g of the lithium-transition metal composite oxide sample was immersed into 50 mL pure water and the pH of the aqueous solution was measured; then, assuming that all the remaining alkali originated from LiOH, its weight percentage was calculated from the amount of [OH]⁻.

TABLE 2

| | | | Percentage |
|---|---|---|---|
| | | | of capacity |
| | | Amount of | degradation |
| | | remaining | after 100 cycles |
| | Battery | alkali (wt. %) | at 45° C. (%) |
| Ex. 1 | A2 | 0.07 | 2.1 |
| Comp. Ex. 1 | B2 | 0.10 | 2.6 |

The results shown in Table 1 clearly demonstrate that the battery A1 of Example 1, which utilized the lithium-transition metal composite oxide coated with microparticles of Al₂O₃ as the positive electrode active material, showed approximately the same level of discharge capacity as that of the battery B1 of Comparative Example 1, which used as the positive electrode active material the lithium-transition metal composite oxide that was not coated with microparticles of Al₂O₃. The battery C1 of Comparative Example 2, which used, as the positive electrode active material, a lithium-transition metal composite oxide in which Al₂O₃ was added internally, showed a lower discharge capacity than those of the battery A1 of Example 1 and the battery B1 of Comparative Example 1. From these results, it is appreciated that coating a lithium-transition metal composite oxide with microparticles of Al₂O₃ according to the present invention does not cause reduction in battery capacity.

Furthermore, the results shown in Table 2 clearly show that the battery A2 of Example 1 had a lower percentage of capacity degradation after 100 cycles at 45° C. than the battery B2 of Comparative Example 1. This demonstrates that the use of the lithium-transition metal composite oxide coated with microparticles of Al₂O₃ according to the present invention improves high-temperature cycle performance. In addition, it is understood that coating, according to the present invention, a lithium-transition metal composite oxide with microparticles of Al₂O₃ serves to reduce the amount of remaining alkali. Thus, coating a lithium-transition metal composite oxide with microparticles of Al₂O₃ can reduce the amount of remaining alkali in the active material and consequently alleviate the decomposition reaction between the remaining alkali and the electrolyte solution, and therefore, it is believed that high-temperature cycle performance improves.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and not for limiting the invention as defined by the appended claims and their equivalents.

This application claims the priority of Japanese Patent Application No. 2004-158781, which is incorporated herein in its entirety by reference.

1. A non-aqueous electrolyte secondary battery, comprising a positive electrode containing a positive electrode active material capable of intercalating and deintercalating lithium, a negative electrode containing a negative electrode active material capable of intercalating and deintercalating lithium, and a non-aqueous electrolyte having lithium ion conductivity, wherein
said positive electrode active material is a layered lithium-transition metal composite oxide at least a part of the surface of which is coated with microparticles of Al₂O₃.

2. The non-aqueous electrolyte secondary battery according to claim 1, wherein said lithium-transition metal composite oxide comprises at least Ni and Mn as transition metals.

3. The non-aqueous electrolyte secondary battery according to claim 1 wherein said positive electrode active material comprises a mixture of said layered lithium-transition metal composite oxide at least a part of the surface of which is coated with microparticles of Al₂O₃ and a lithium-manganese composite oxide having a spinel structure.

4. The non-aqueous electrolyte secondary battery according to claim 2, wherein said positive electrode active material comprises a mixture of said layered lithium-transition metal composite oxide at least a part of the surface of which is coated with microparticles of Al₂O₃ and a lithium-manganese composite oxide having a spinel structure.
